(19) United States
(12) Patent Application Publication
(10) Pub. No.: US 2015/0053345 A1
(43) Pub. Date: Feb. 26, 2015

(54) SOLVENT WELDING AGENT AND USE OF A SOLVENT WELDING AGENT

(71) Applicant: Ewald Dörken AG, Herdecke (DE)

(72) Inventors: Jörn Schröer, Herdecke (DE); Carsten Harfmann, Frankfurt (DE)

(73) Assignee: Ewald Dörken AG, Herdecke (DE)

(21) Appl. No.: 14/464,889

(22) Filed: Aug. 21, 2014

(30) Foreign Application Priority Data
Aug. 23, 2013 (DE) 10 2013 013 974.0
Sep. 17, 2013 (DE) 10 2013 015 344.1
Sep. 26, 2013 (DE) 10 2013 015 994.6
Oct. 11, 2013 (DE) 10 2013 016 973.9

(51) Int. Cl. C08K 5/1545; C08K 5/101; C08K 5/07; B32B 37/12; C08K 5/41

(52) U.S. Cl. CPC C08K 5/1545; B32B 37/12; C08K 5/41; C08K 5/07; C08K 5/101
USPC 156/308.6; 106/287.24; 106/287.2

(57) ABSTRACT

A solvent welding agent used for bonding of polymer surfaces in the region of a contact zone, especially for bonding of polymer surfaces of webs in the construction field. The solvent welding agent contains a solvent for dissolving a polymer and a mass transport promoter for promoting the mass transport of the solvent welding agent, especially of the solvent, from the contact zone between the polymer surfaces.

### BACKGROUND OF THE INVENTION

1. Field of the Invention

The invention relates to a solvent welding agent for bonding of polymer surfaces in the region of a contact zone, especially a solvent welding agent for bonding of polymer surfaces of webs in the construction field, which contains a solvent for dissolving a polymer. Furthermore, the invention relates to the method of the utilization of a solvent welding agent for bonding of a first polymer surface, which is especially the polymer surface of a web for the construction field, to a second polymer surface, which is especially the polymer surface of a second web from the construction field.

2. Description of Related Art

Solvent welding within the scope of this invention is a joining technique that is used to join polymer surfaces to one another. Solvent welding (i.e., bonding without the use of an adhesive) is wherein a solvent is applied to the surfaces that are to be joined for partial dissolving of the surfaces, and the surfaces to be joined are thereupon brought into contact with one another, whereupon a coalesced joint is produced. In doing so, when the bond forms, the polymer molecules that have been dissolved by the solvent diffuse into the respectively opposite surface. This joining technique is also referred to as “cold welding”.

The advantage of solvent welding is that it constitutes a simple and economical method for producing a bond between two bodies with polymer surfaces. Another advantage of solvent welding is that a solvent welded joint is comparatively insensitive to thermal fluctuations. For example, solvent welded joints are generally less sensitive to thermal fluctuations than cementing.

One application in which solvent welding is advantageously used is the joining of webs with polymer surfaces in the construction field. There, for example, polyvinyl chloride surfaces, for example, for sealing of flat roofs, are solvent-welded. In the case of steep roofs, webs with polymer surfaces are likewise used, especially regarding the sub-roof construction. These polymer webs, which are also referred to as sub-roof membranes, shall be necessarily bonded among one another within the scope of Standard SIA 232-1/2011-8. The polymer surfaces of these sub-roof membranes that are to be bonded generally consist of thermoplastic polyurethane (TPU).

In practice, as a solvent welding agent, i.e., as the solvent, which is applied to the surfaces to be joined for joining the surfaces, tetrahydrofuran (THF) is currently used exclusively. Likewise, mixtures of THF and other organic substances, such as, for example, cyclohexanone or 2-butanone, are used.

These solvent welding agents that are based in their effect essentially on THF are characterized by good solvency of the THF for the polymers that are used in practice, this solvency resulting in high stability of the solvent welded joint. In this sense, a high stability of a solvent welded joint is considered especially a high stability of the solvent welded joint that is established 24 hours after the polymer surfaces to be joined have been brought into contact with one another. This strength is hereinafter referred to as stability (24 hours).

The stability of a solvent welded joint rises first after the polymer surfaces are brought into contact. This rise in stability results from the solvent volatilizing by mass transport processes from the contact zone between the polymer surfaces. In doing so, the mass transport associated with the solvent volatilization can take place both through the polymer surfaces themselves and also from the gap between the surfaces to be joined directly into the vicinity of the solvent welded joint, i.e., generally into the gaseous phase.

In practice, it is important that high stability of the solvent welded joint can not only be achieved after a sufficiently long waiting time, but a certain stability of the solvent welded joint must also be achieved even after a short time, for example, five minutes. This must be sufficient at least to enable further processing of the surfaces to be joined before the final stability of the solvent welded joint is reached after a finite waiting time. THF generally enables further processing after a comparatively short exposure time.

The disadvantage in the use of THF is, however, that it is regarded as hazardous to health and is suspected of being a carcinogen. Furthermore, THF can form explosive peroxides.

### SUMMARY OF THE INVENTION

The primary object of this invention is now to provide a solvent welding agent that has lower risks, especially for health and with respect to safety in processing, than known solvent welding agents, but at the same time allows sufficiently prompt further processing and sufficient stability of the solvent welded joint.

This object is achieved by a solvent welding agent and the use thereof as described herein.

It is provided according to the invention that the solvent welding agent contains a mass transport promoter for promoting the mass transport of the solvent welding agent, especially of the solvent, out of the contact zone between the polymer surfaces, especially of the overlapping webs.

Especially preferably, not only the solvent, but also the entire solvent welding agent as such is removed more quickly from the contact zone between the polymer surfaces by the mass transport promoter. As a consequence the stability of the solvent welded joint rises more quickly. The invention makes it possible to use solvents that would not be used in conventional solvent welding agents due to their poor inherent mass transport capacity, although in themselves, they have a sufficient solvency for the polymer surfaces to be bonded, and for example, with respect to health toxicity, they have advantages over the established tetrahydrofuran.

Advantageously, the solvent welding agent according to the invention contains less than 1% by weight of tetrahydrofuran (THF). Thus, the invention takes a completely new approach and differs from the known THF solvent welding agents. The solvent welding agent according to the invention with this content of THF has an acceptably low hazard potential. Here, it has been shown, surprisingly enough, that it is possible to enable sufficiently high stability of the solvent welded joint and a sufficiently short exposure time even with this THF content in the solvent welding agents according to the invention.

Especially advantageously, the solvent welding agent contains no THF. The complete elimination of THF results in the most extensive minimization of the risks resulting from the THF.

It has been found, surprisingly enough, that especially dimethyl sulfoxide (DMSO) is suitable as a solvent in a solvent welding agent according to the invention. DMSO has the advantage of, on the one hand, having a sufficiently high solvency for the polymers under consideration for solvent welding and, on the other hand, constituting a sufficiently low risk to human health. Alternatively or in combination therewith, suitable solvents are also dimethylformamide (DMF) and/or n-methylpyrrolidone (NMP). Here, the selection of the solvent is limited neither to organic substances nor pure substances. Fundamentally, substances such as, for example, water or mixtures of substances, for example, a mixture of the aforementioned pure substances preferred as solvents, are also suitable as solvents. It goes without saying that a mixture of pure substances in this connection can also be considered in particular a mixture of chemical compounds.

The mass transport promoter can likewise be a pure substance or a mixture of substances. Here, it goes without saying that a mixture of substances can also be defined in particular as a mixture of different chemical compounds in this connection.

A characteristic of the mass transport promoter that is critical to the invention is its suitability for promoting the stabilization of the solvent welded joint. This is based especially on the property that this agent transports in as short a time as possible the solvent welding agent and especially the solvent out of the contact zone between the polymer surfaces. Thus, in the invention, solvents can be used that have a dissolving behavior that is outstanding for the polymer, but as such would never have been used for a solvent welding agent due to their poor volatility.

The invention consequently uses the synergistic effect of a mixture of two agents that each entail primarily one of the properties that are combined in THF in conventional solvent welding agents. The solvent at least essentially provides the solvency of the solvent welding agent according to the invention relative to the polymer. The mass transport promoter provides, however, at least essentially a sufficiently prompt removal of the solvent welding agent according to the invention from the contact zone and thus accelerates the stabilization of the resulting solvent welded joint.

While, for conventional solvent welded joints, it was attempted to use a solvent that combines the two aforementioned properties of the two agents in itself, according to the invention two agents will now be selected. Taken for themselves, they must have only one of the aforementioned properties and impart it to the solvent welding agent according to the invention. In this way, a plurality of agents for the solvent welding agent according to the invention are suitable, which would have been unsuitable in conventional solvent welding agents. The possibility of choosing from a larger pool of possible contents makes it possible to optimize the solvent welding agent with respect to other properties. These properties include especially a health risk that is as low as possible.

The mass transport can take place both based on the diffusion of the solvent welding agent through the polymer that forms the polymer surface, and also by volatilization, in particular evaporation, of the solvent welding agent out of the contact zone between the polymer surfaces to the vicinity, therefore according to the principle of effusion from a gap between the polymer surfaces. Generally, in practice, a combination or superposition of the two mass transport mechanisms will be observed.

Within the scope of this invention, a mass transport promoter is considered especially an agent that increases the rate of the rise of the stability of the solvent welded joint after the polymer surfaces have been brought into contact, especially by accelerating the progression of the above-described mass transport phenomena, and accelerates the increase of the stability of the solvent welded joint after the polymer surfaces have been brought into contact.

The stability of a solvent welded joint can be determined in the case of roof sealing webs, for example, according to standard DIN EN 12317-2 “Sealing Webs—Determination of the Shearing Resistance of Joint Seams—Part 2: Plastic and Elastic Webs for Roof Seals” (“Abdichtungsbahnen—Bestimmung des Share-Widerstandes der Fügennähte—Teil 2: Kunststoff and Elastomerbahnen für Dachabdichtungen”) with the shearing force or shearing resistance as a measure of the stability.

According to this standard, the earliest instant at which the stability of a solvent welded joint is determined is 20 hours after the surfaces to be joined have been brought into contact. With respect to prompt further processing, however, especially the stability after a shorter time, especially 5 minutes, is important. Hereinafter, this is referred to as stability (5 minutes).

Within the scope of this invention, therefore, a mass transport promoter is especially regarded as such when it sufficiently raises the stability of the solvent welded joint, especially 5 minutes after the polymer surfaces have been brought into contact. In this case, in particular a doubling, especially preferably a quadrupling, of the stability (5 minutes) compared to the stability (5 minutes) that can be achieved with the pure solvent is referred to as a sufficient rise. In this case, in particular, the stability (5 minutes) is determined according to standard DIN EN 12317-2, provided that the measurement of the shearing force as a measure of the stability (5 minutes) does not take place, as provided in the standard, at the earliest 20 hours after the polymer surfaces have been brought into contact, but rather 5 minutes after the polymer surfaces have been brought into contact.

In doing so, a mass transport promoter in particular is also considered as such within the scope of this invention when by adding the mass transport promoter to the solvent, the attainable stability (5 minutes) can be raised compared to the pure solvent to a value of >50 N, preferably >100 N. In this case, the stability (5 minutes) is determined in particular according to DIN EN 12317-2 with the proviso that the measurement of the shearing resistance or shearing force is carried out as a measure of the stability (5 minutes) 5 minutes after the polymer surfaces have been brought into contact.

The concentration of the mass transport promoter in the solvent welding agent is in this case preferably at most 99% by weight, furthermore preferably at most 83% by weight, furthermore preferably at most 73% by weight, and furthermore preferably at most 50% by weight. The concentration of the mass transport promoter in the solvent welding agent is in this case preferably at least 25% by weight, furthermore preferably at least 50% by weight, furthermore preferably at least 73% by weight, and furthermore preferably at least 83% by weight.

The concentration of the solvent in the solvent welding agent is preferably at most 75%, furthermore preferably at most 50%, furthermore preferably at most 40%, furthermore preferably at most 27%, and furthermore preferably at most 17%. The concentration of the solvent in the solvent welding agent is preferably at least 1%, furthermore preferably at least 17%, furthermore preferably at least 27%, furthermore preferably at least 40%, and furthermore preferably at least 50%.

Preferably, the concentration of the solvent is 1% by weight to 75% by weight, and the concentration of the mass transport promoter is 25% by weight to 99% by weight. Here, the solvent welding agent according to the invention can contain other components up to 74% by weight. Especially preferably, the concentration of the solvent is 25% by weight to 40% by weight, and the concentration of the mass transport promoter is 60% by weight to 75% by weight. In this case, the solvent welding agent according to the invention can contain other components up to 15% by weight.

Preferably, the solvent welding agent contains at least one dissolved polymer. The dissolved polymer can be polystyrene (PS), polyisobutylene (PIB), polymethyl methacrylate (PMMA), ethylene vinyl acetate (EVA), polyvinyl chloride (PVC) and/or thermoplastic polyurethane (TPU).

Preferably, the mass transport promoter is a high-volatile, medium-volatile or low-volatile substance or a high-volatile, medium-volatile or low-volatile mixture of substances. Here, the terms high-volatile, medium-volatile or low-volatile are defined by the so-called evaporation number. The latter is a dimensionless relative characteristic that describes the evaporation of a substance in relation to a reference substance. This reference substance is diethyl ether. In this case, evaporation numbers from 10 to 35 correspond to “medium-volatile,” evaporation numbers less than 10 correspond to “high-volatile,” and evaporation numbers from 35 to 50 correspond to “low-volatile.” The mass transport promoter here preferably has an evaporation number of at most 50, especially preferably an evaporation number of at most 35.

The mass transport promoter is selected in particular from the following:
The group of alcohols, such as, for example, methanol, ethanol, isopropanol and n-propanol, and/or
The group of ketones, such as, for example, acetone, butanone, methyl isobutyl ketone, or cyclohexanone, and/or
The group of ethers, such as, for example, 2-methyltetrahydrofuran, 1,4-dioxane, or tetrahydropyran, and/or
The group of ether group-containing alcohols, such as, for example, methyl glycol, ethoxypropanol, or methoxypropanol, and/or
The group of esters, such as, for example, acetic acid methyl ester, acetic acid ethyl ester, acetic acid propyl ester, acetic acid butyl ester, and acetic acid methoxypropyl ester, and/or
The group of aromatic compounds, such as, for example, benzene, xylene, aromatic-compound-containing gasolines, and/or
The group of aliphatic compounds, such as, for example, cyclohexane, petroleum ether, or gasoline.

Preferably, the mass transport promoter itself is not suited as a solvent welding agent, because it does not have sufficient solvency for polymers, especially for thermoplastic polyurethane (TPU), polystyrene (PS), polyisobutylene (PIB), polymethyl methacrylate (PMMA), ethylene vinyl acetate (EVA), and/or polyvinyl chloride (PVC) and thus does not lead to sufficient stability (24 hours) of the solvent welded joint. A stability of more than 250 N shearing resistance in a determination according to DIN EN 12317-2 is regarded as sufficient. Here, material rupture occurs preferably outside of the material region directly affected by the solvent welded joints.

Furthermore, the invention relates to the method of the utilization of a solvent welding agent according to the invention for bonding of a first polymer surface, especially of a first polymer surface of a first web for the construction field, of a first polymer, to a second polymer surface, especially a second polymer surface of a second web from the construction field, of a second polymer.

Here, the solvent preferably has a higher solvency than the mass transport promoter for the first polymer and/or for the second polymer.

Here, the first polymer and/or the second polymer is preferably thermoplastic polyurethane (TPU), polystyrene (PS), polyisobutylene (PIB), polymethyl methacrylate (PMMA), ethylene vinyl acetate (EVA), or polyvinyl chloride (PVC), and/or a copolymer of the aforementioned polymers and/or a mixture of the aforementioned polymers and/or copolymers.

Here, the first web for the construction field and/or the second web for the construction field is preferably a flat roof web and/or an sub-roof membrane. These webs can be made diffusion-open or diffusion-tight, or, as a vapor barrier. Here, the contact zone corresponds to an overlapping region between two webs and/or is part of an overlapping region between two webs.

Here, the aforementioned features of the invention can be advantageously implemented in any combinations with one another. Furthermore, if the boundaries of the value ranges are indicated, all particular individual values that lie within the respective value range and intermediate intervals are also possible and accordingly disclosed without the necessity of explicit naming of each individual value or intermediate interval.

This invention is explained in more detail by the advantageous embodiments described below; this invention, however, is in no case limited to the embodiments.

### BRIEF DESCRIPTION OF THE DRAWINGS

FIG. 1 shows a schematic view of a typical installation situation of solvent welded webs in the construction field,

FIG. 2 shows a schematic cross-sectional view of a solvent welded joint immediately after the surfaces have been brought into contact,

FIG. 3 shows a schematic cross-sectional depiction of a solvent welded joint after stabilization has been completed, and

FIG. 4 shows a schematic cross-sectional depiction of an sub-roof membrane.

### DETAILED DESCRIPTION OF THE INVENTION

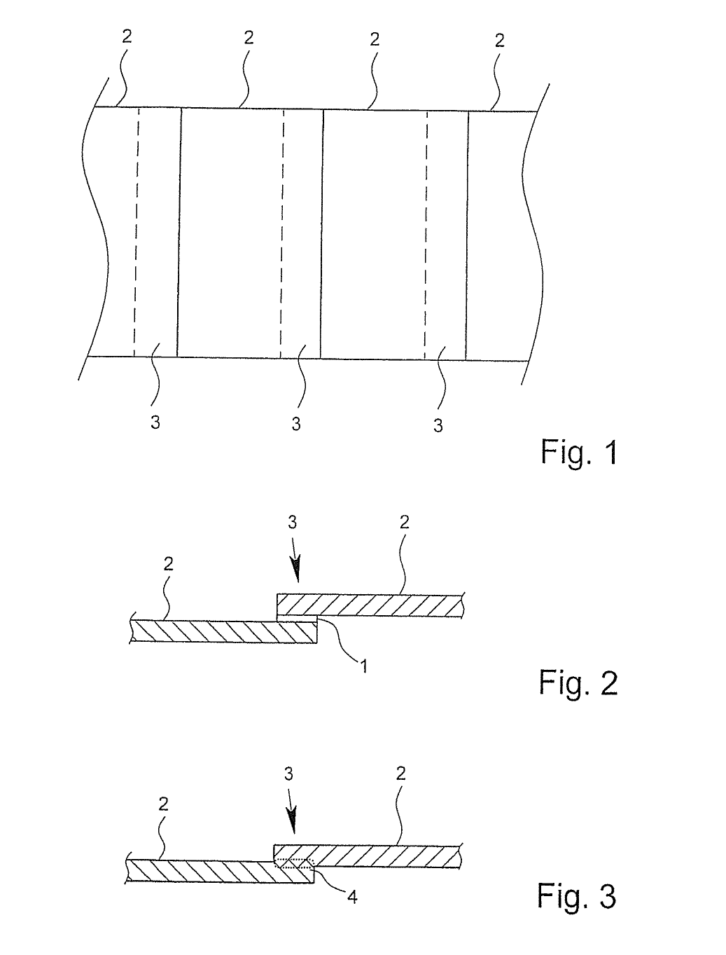

As an exemplary application for the method of the utilization of a solvent welding agent 1 according to the invention, FIG. 1 shows the solvent welded joint of a plurality of webs 2 as used in the construction field. The webs 2 that are joined one to another can, for example, form a watertight and diffusion-open or diffusion-tight outer skin for a building or a roof or an outer skin made as a vapor barrier. The webs 2 overlap one another in the regions 3. In the overlapping region 3, the solvent welding agent 1 is introduced as a film between the webs 2, as is schematically shown in FIG. 2. This yields a contact zone 4 between the polymer surfaces of the webs 2, which surfaces are to be bonded. The webs 2 are joined in the contact zone 4, in which the polymers of the webs 2 that have been partially dissolved by the solvent welding agent 1 diffuse into the respectively opposite web 2. At the same time, the solvent welding agent 1 is removed from the contact zone 4 between the webs 2 by mass transport, whereby the solvent welded joint is stabilized. The situation after the complete stabilization of the solvent welded joint is shown schematically in FIG. 3. Some examples of solvent welding agents according to the invention and of a thus-produced solvent welded joint are indicated below.

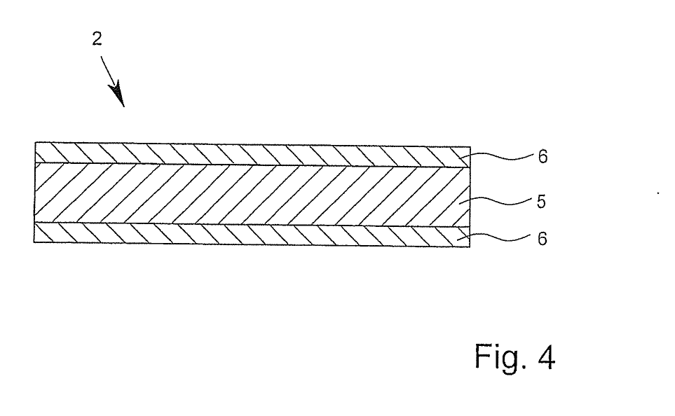

Here, for the examples indicated below for the use of solvent welding agents 1 according to the invention to produce solvent welded joints, by way of example sample bodies from a symmetrical sub-roof web 2 are used. A cross-section of one such symmetrical sub-roof web is shown in FIG. 4. The sub-roof web 2 consists of a middle nonwoven fabric carrier layer 5 and polymer layers 6 that have been applied to it on the top and bottom. The nonwoven fabric carrier layer 5 in the selected example is preferably a polyester nonwoven fabric and has a tensile strength of at least 250 N/5 cm according to EN 12311-1:1999. The polymer layers 6 extruded in a grammage of 100 g/m² are applied to the nonwoven fabric carrier layer 5.

Alternatively, the use of sample bodies without a carrier layer would also be possible. They can be formed of, for example, a polymer and can be designed in their thickness such that they have a tensile strength of at least 250 N/5 cm according to EN 12311-1:1999.

The use of these sample bodies is chosen only by way of example below; in practice, the use of solvent welding agents 1 according to the invention will take place on actual components, especially actual webs 2 for the construction field. Standardized sample bodies from suitable sub-roof webs were chosen only to depict the action of the solvent welding agents 1 according to the invention in a comparable manner.

It applies to the examples cited below that the tensile strength of the polyester nonwoven fabric 5 of the sample body used is 400 N/5 cm with a tolerance of +/−20%, therefore 320 N/5 cm to 480 N/5 cm. The polymer layers 6 consist of TPU.

The sample bodies are joined at a length of 1 m with an overlap of 5 cm by solvent welding between the overlapping polymer layers 6 in the contact zone 4 in the overlapping region 3 of the webs 2. In doing so, the solvent welding agent 1 is applied or introduced into the overlapping region with a brush in a dose of 5 ml per solvent welded joint. This can take place on the surface of one web or the surfaces of the two webs in the region of the contact zone 4. The overlapping region is then pressed together with a pressing roller.

In this case, the processing and subsequent storage take place at a temperature of 23° C. and a relative atmospheric humidity of between 30% and 70%.

The stability of the solvent welded joint is thereupon determined according to DIN EN 12317-2. The shearing force that has been determined in this way 24 hours after the polymer layers 6 have been brought into contact is considered a measure of the stability (24 hours) of the solvent welded joint.

In the same manner, but in this respect deviating from the aforementioned standard that the determination of the shearing force takes place as early as after 5 minutes after the polymer layers 6 have been brought into contact, the shearing force is determined as a measure of the stability (5 minutes).

According to one comparison example, pure DMSO is used as the solvent welding agent.

After an exposure time of 5 minutes, the shearing force as a measure of the stability (5 minutes) of the solvent welded joint is only 22 N. The shearing force after 24 hours as a measure of the stability (24 hours) of the solvent welded joint is 300 N. Rupture takes place within the region of the solvent welded joint. After 24 hours, there is still liquid or viscous DMSO between the polymer surfaces.

According to a first embodiment of this invention, a mixture of 50% by weight of DMSO and 50% by weight of acetone is used as solvent welding agent.

After an exposure time of 5 minutes, the shearing force as a measure of the stability (5 minutes) of the solvent welded joint is 94 N. The shearing force after 24 hours as a measure of the stability (24 hours) of the solvent welded joint is 345 N. Rupture takes place outside of the region of solvent welded joint.

According to a second embodiment of this invention, a mixture of 27% by weight of DMSO and 73% by weight of acetone is used as solvent welding agent.

After an exposure time of 5 minutes, the shearing force as a measure of the strength (5 minutes) of the solvent welded joint is 123 N. The shearing force after 24 hours as a measure of the strength (24 hours) of the solvent welded joint is 359 N. Rupture takes place outside of the region of solvent welded joint.

According to a third embodiment of this invention, a mixture of 20% by weight DMSO and 80% by weight acetone is used as solvent welding agent.

After an exposure time of 5 minutes, the shearing force as a measure of the stability (5 minutes) of the solvent welded joint is 242 N. The shearing force after 24 hours as a measure of the stability (24 hours) of the solvent welded joint is 365 N. Rupture takes place outside of the region of solvent welded joint.

According to a fourth embodiment of this invention, a mixture of 27% by weight DMSO and 73% by weight of acetone is used as solvent welding agent. In this embodiment, the processing, storage and measurement of the shearing forces take place at 0° C.

After an exposure time of 5 minutes, the shearing force as a measure of the stability (5 minutes) of the solvent welded joint is 356 N. The shearing force after 24 hours of storage as a measure of the stability (24 hours) of the solvent welded joint is 411 N. Rupture takes place outside of the region of solvent welded joint.

According to a fifth embodiment of this invention, a mixture of 17% by weight DMSO and 83% by weight tetrahydropyran is used as solvent welding agent.

After an exposure time of 5 minutes, the shearing force as a measure of the stability (5 minutes) of the solvent welded joint is 210 N. The shearing force after 24 hours as a measure of the stability (24 hours) of the solvent welded joint is 423 N. Rupture takes place outside of the region of solvent welded joint.

According to a sixth embodiment of this invention, a mixture of 27% by weight DMSO and 73% by weight acetic acid butyl ester is used as solvent welding agent.

After an exposure time of 5 minutes, the shearing force as a measure of the stability (5 minutes) of the solvent welded joint is 190 N. The shearing force after 24 hours as a measure of the stability (24 hours) of the solvent welded joint is 378 N. Rupture takes place outside of the region of solvent welded joint.

According to a seventh embodiment of this invention, a mixture of 27% by weight DMSO and 73% by weight acetic acid-1-methoxy-2-propylester (PMA) is used as solvent welding agent.

After an exposure time of 5 minutes, the shearing force as a measure of the stability (5 minutes) of the solvent welded joint is 120 N. The shearing force after 24 hours as a measure of the stability (24 hours) of the solvent welded joint is 390 N. Rupture takes place outside of the region of solvent welded joint.

According to an eighth embodiment of this invention, a mixture of 27% by weight DMSO, 30% by weight acetone, and 43% by weight of acetic acid-1-methoxy-2-propylester (PMA) is used as solvent welding agent.

After an exposure time of 5 minutes, the shearing force as a measure of the stability (5 minutes) of the solvent welded joint is 114 N. The shearing force after 24 hours as a measure of the stability (24 hours) of the solvent welded joint is 355 N. Rupture took place outside of the region of solvent welded joint.

What is claimed is:

1. Solvent welding agent for bonding of polymer surfaces in the region of one contact zone of webs, comprising:
a solvent for dissolving a polymer, and
a mass transport promoter for promoting the mass transport of the solvent welding agent out of the contact zone between the polymer surfaces.

2. Solvent welding agent according to claim 1, wherein the solvent welding agent comprises a mass transport promoter for promoting the mass transport of the solvent out of the contact zone between the polymer surfaces.

3. Solvent welding agent according to claim 1, wherein the solvent welding agent contains less than 1% by weight of tetrahydrofuran.

4. Solvent welding agent according to claim 1, wherein the mass transport promoter is suitable for accelerating the rise of the stability of the solvent welded joint after the polymer surfaces have been brought into contact in relation to the use of the pure solvent as solvent welding agent.

5. Solvent welding agent according to claim 1, wherein the mass transport promoter is suitable for at least doubling the stability of the solvent welded joint that is reached 5 minutes after the polymer surfaces have been brought into contact.

6. Solvent welding agent according to claim 1, wherein the mass transport promoter is suitable for at least quadrupling the stability of the solvent welded joint that is reached 5 minutes after the polymer surfaces have been brought into contact.

7. Solvent welding agent according to claim 1, wherein the solvent has a higher evaporation number than the mass transport promoter.

8. Solvent welding agent according to claim 1, wherein the mass transport promoter has an evaporation number of at most 50.

9. Solvent welding agent according to claim 1, wherein the solvent is selected from the group dimethyl sulfoxide (DMSO), n-methylpyrrolidone (NMP), dimethyl formamide (DMF), and mixtures of the aforementioned substances.

10. Solvent welding agent according to claim 1, wherein the mass transport promoter is a material selected from the group consisting of alcohols, ether group-containing alcohols, ketones, ethers, esters, aromatic compounds, aliphatic compounds, and mixtures of the aforementioned substances.

11. Solvent welding agent according to claim 1, wherein the solvent has a higher solvency for thermoplastic polyurethane (TPU), polystyrene (PS), polyisobutylene (PIB), polymethyl methacrylate (PMMA), ethylene vinyl acetate (EVA), and polyvinyl chloride (PVC) than the mass transport promoter.

12. Solvent welding agent according to claim 1, wherein the solvent is suitable for producing a solution with a proportion of at least 0.1% by weight of a material selected from the group consisting of thermoplastic polyurethane (TPU), polystyrene (PS), polyisobutylene (PIB), polymethyl methacrylate (PMMA), ethylene vinyl acetate (EVA), polyvinyl chloride (PVC), and mixtures of the aforementioned substances.

13. Solvent welding agent according to claim 1, wherein the solvent is suitable for producing a solution with a proportion of at least 1% by weight to 25% by weight of a material selected from the group consisting of thermoplastic polyurethane (TPU), polystyrene (PS), polyisobutylene (PIB), polymethyl methacrylate (PMMA), ethylene vinyl acetate (EVA), polyvinyl chloride (PVC), and mixtures of the aforementioned substances.

14. Solvent welding agent according to claim 1, wherein the mass proportion of the solvent in the solvent welding agent is at most 75%.

15. Solvent welding agent according to claim 1, wherein the mass proportion of the solvent in the solvent welding agent is at most 40% by weight and is at least 1%.

16. Solvent welding agent according to claim 1, wherein the mass proportion of the mass transport promoter in the solvent welding agent is between 99% by weight and 25% by weight.

17. Method of bonding a first polymer surface to a second polymer surface, comprising the steps of:
providing a solvent welding agent in a contact zone between a first polymer surface of a first web of a construction material and a second polymer surface of a second web of a construction material, the solvent welding agent comprising a polymer dissolving solvent and a mass transport promoter,
wherein the mass transport promoter promotes the mass transport of the solvent welding agent out of the contact zone between the polymer surfaces.

18. Method of bonding according to claim 17, wherein the solvent used has a higher solvency for the first and second polymers than the mass transport promoter used.

19. Method of bonding according to claim 17, wherein the first polymer and the second polymer are selected from the group consisting of thermoplastic polyurethane (TPU), polystyrene (PS), polyisobutylene (PIB), polymethyl methacrylate (PMMA), ethylene vinyl acetate (EVA), polyvinyl chloride (PVC), and mixtures of the aforementioned substances.

20. Method of bonding according to claim 17, wherein the first polymer surface and the second polymer surface are used to form a surface of a roof web.
